(19) United States
(12) Patent Application Publication
(10) Pub. No.: US 2020/0094334 A1
(43) Pub. Date: Mar. 26, 2020

(54) DEVICE AND METHOD FOR LAPPING GEAR WHEEL PAIRS

(71) Applicant: Klingelnberg AG, Zürich (CH)

(72) Inventors: Stefan Herzhoff, Hückeswagen (DE); Christian Pahud, Uitikon (CH); Dominik Widmann, Stühlingen (DE); Bastian Hermanns, Zürich (CH)

(21) Appl. No.: 16/580,413

(22) Filed: Sep. 24, 2019

(30) Foreign Application Priority Data
Sep. 25, 2018 (EP) 18196573.2

(51) Int. Cl. B23F 1/02; B23F 21/02

(52) U.S. Cl. CPC B23F 1/02; B23F 21/02

(57) ABSTRACT

Method comprising:
a) specifying a target ease-off for a first pair of gear wheels from a number of structurally-equivalent gear wheel pairs,
b) carrying out a first lapping procedure on the first gear wheel pair,
c) carrying out a measurement procedure on the first gear wheel pair to acquire multiple measured values on tooth flanks of both gear wheels,
d) ascertaining the actual ease-off of the first gear wheel pair from the measured values,
e) ascertaining deviations of the actual ease-off in relation to the target ease-off,
f) ascertaining correction values on the basis of the deviations,
g) defining an adapted lapping procedure on the basis of the correction values, and
h) either carrying out a further, adapted lapping procedure on the first gear wheel pair,
i) or carrying out an adapted lapping procedure on a second gear wheel pair from the number of structurally-equivalent gear wheel pairs.

### CROSS-REFERENCE TO RELATED APPLICATIONS

This application claims the benefit under 35 U.S.C. § 119(e) to European patent application no. EP18196573.2 filed Sep. 25, 2018, which is hereby expressly incorporated by reference as part of the present disclosure.

### FIELD OF THE INVENTION

The present disclosure relates to a device and a method, such as for lapping wheelset pairs, for example.

### BACKGROUND

A lapping method is frequently used for the hard-fine machining in the scope of the manufacturing of bevel gears. Lapping is a method which is used for the hard-fine machining (finish machining after the hardening) of the tooth faces of bevel gear pairs (bevel gear units) or hypoid gear pairs (hypoid gear units). In contrast to gear-cutting grinding, in which abrasive grains are permanently bound into the matrix of the grinding tool and the cutting path is thus geometrically determined, lapping operates using loose particles, which form a suspension (called lapping liquid or lapping agent) with a suitable carrier liquid. The lapping agent is introduced for the purposes of lapping into the engagement region between the gears of the wheelset pair in such a way that between the two gears—with specification of a specific torque load—an abrasive material removal results. At the same time, the lapping ensures the running in of the gears of the wheelset pair.

Carrying out a lapping method on bevel gears and hypoid gears requires a special machine structure having a corresponding axis arrangement, wherein such a lapping machine has at least five axes (for example, three linear axes and two rotational axes), which can be moved. In addition, a lapping machine can have an axial angle adjustment.

The top view of an exemplary lapping machine 10 is shown in FIG. 1 in greatly simplified form. A lapping machine 10 comprises, for example, a first spindle 11 for accommodating a crown gear T, wherein the crown gear T is mounted so it is rotatable around the crown gear axis TA in the chucked state. In addition, there is a second spindle 12, which is designed to accommodate a pinion R. The second spindle 12 enables the rotation of the pinion R around the pinion axis RA.

The lapping machine 10 shown by way of example in FIG. 1 has a total of five axes, to enable the engagement rotations and the movements required for the lapping (for displacing the lapping region) between pinion R and crown gear T. In total, the following five axes are provided in the lapping machine 10 shown: two rotational axes TA, RA for the engagement rotation and three linear axes LA1, LA2, LA3. The axes can also be arranged differently.

The lapping machine 10 of FIG. 1 enables a relative movement parallel to the crown gear axis TA and a relative movement parallel to the pinion axis RA. In addition, the distance between the crown gear axis TA and the pinion axis RA can typically be adjusted (for example, by the use of the LA3 linear axis). The corresponding linear displacements are also used to adapt the installation dimension of the wheelset pair to be lapped.

After a crown wheel T has been fastened on a first spindle 11 and a pinion R to be paired therewith has been fastened on a second spindle 12 in such a lapping machine 10, as schematically shown in FIG. 1, the pinion R is typically driven while the crown gear T runs along or is braked, respectively, in engagement with the pinion R. While the two gears T and R thus execute a continuous engagement rotation, the lapping agent (for example, an oil with silicon carbide) is used as an abrasive. The mentioned movement(s) are executed during the lapping to extend the lapping action onto the tooth flanks surface of both gears T and R.

Machines are offered by the producers of lapping machines which essentially differ from one another by way of differently designed relative movements. Some lapping machines can execute three linear movements, wherein the two horizontal movements LA1, LA2 are necessary, since otherwise a displacement of the pinion R would result very rapidly in the consumption of the flank play and in jamming if the crown gear T were not moved along accordingly. A vertical axis LA3 is required for the lapping of hypoid gear units to set the axial offset and can also be used, of course, for the wear pattern displacement during the lapping.

A device is known from the published European patent application no. EP2875893A1, which is designed as a test machine and as a lapping machine. This device comprises three linear axes LA1, LA2, LA3, which together form a Cartesian coordinate system. In addition, this device comprises two spindle groups each having one spindle rotational axis.

Another lapping machine and a method for monitored controlled lapping are known from the European patent no. EP2079556B1.

The simultaneous machining of the two gears enhances the productivity of the method. However, the lapping displays a significant dependence of the removal effect on the starting geometry of the gears after the hardening.

In the milling and grinding of gear wheels, it is possible to ascertain the microgeometry to be produced by computer and to control the milling and grinding method accordingly, for example, in a closed-loop approach. In contrast, an accurate prediction of the removal effect and the microgeometry of the tooth flanks of the gears has heretofore only been possible to a limited extent in lapping.

This is because, inter alia, there is an entire array of variables (for example, the surface hardness of the tooth flanks, the present topography of the tooth flanks after the hardening, the concentration, size, and quality of the particles of the lapping agent, the lubricating effect of the lapping agent, etc.) in lapping, which have a direct or indirect influence on the removal rate. In addition, it is to be taken into consideration that the removal rate varies from point to point because of dynamic influences. Furthermore, the material removal on the pinion is greater than on the crown gear, since the pinion has fewer teeth.

There are approaches for computing abrasive grinding procedures, as occur during gear-cutting lapping, but an accurate computation or a technical simulation of the procedures has heretofore not been possible, particularly because there are numerous nonlinear relationships which have to be taken into consideration.

The experience of the machine operator has therefore played a large role until today in gear-cutting lapping.

### SUMMARY

It is therefore an objective to make gear-cutting lapping of gear wheel pairs more efficient and to be able to use gear-cutting lapping in a more controlled manner.

At least some embodiments utilize a closed-loop approach, in which a first gear wheel pair, which comprises a pinion and a crown gear, is lapped in a first pass. This first pass is used to achieve an ease-off for the gear wheel pair, which corresponds to a target ease-off or which approximates the target ease-off within tolerances. The tooth flanks of the gear wheel pair are measured after the lapping to be able to ascertain the actual ease-off by computer and/or analytically. A possible deviation of the actual ease-off from the target ease-off is used to either perform a correction or compensation of the lapping procedure for further lapping of the first gear wheel pair, or to perform a correction or compensation of the lapping procedure, which was previously used for the lapping, for the lapping of a further gear wheel pair. The further lapping of the first gear wheel pair is only performed if the first gear wheel pair has a sufficiently large oversize after carrying out the first lapping procedure. Without sufficient oversize, it is not reasonable to lap the first gear wheel pair again.

At least some embodiments utilize a type of closed-loop approach, which can be considered to be a self-optimizing system in a certain scope. The principle of self-optimization has certain limits in lapping, however, since lapping only enables a small material removal and since the lapping builds on empirically ascertained values and/or on simulation-based values. In addition, lapping involves the pairing of two gears. Because these embodiments are based on the specification of a target ease-off and the comparison to an actual ease-off, however, the strengths of a closed-loop approach can also be made useful here.

The method of at least some embodiments implements a closed-loop approach, wherein the method is controlled and/or influenced in such a way that a convergence in the direction of the desired target ease-off occurs rapidly during the lapping of at least one gear wheel pair, or during the lapping of multiple gear wheel pairs of a set of structurally-equivalent pairs.

Bevel gear and hypoid gear pairs which are design-equivalent are referred to here as structurally-equivalent gear wheel pairs. This means these are gear wheel pairs which are theoretically identical. However, since variations occur during the manufacturing and handling of gear wheel pairs, the gear wheel pairs are not identical in practice. These are, for example, the gear wheel pairs of a manufacturing batch or mass production.

In at least some embodiments, the target ease-off can be used to define a set of structurally-equivalent gear wheel pairs. The gear wheel pairs of this set are considered to be structurally equivalent if they—respectively observed as a pair—have an identical or nearly identical wear pattern.

At least some embodiments relate to the lapping of bevel gear pairs and of hypoid gear pairs. For example, these embodiments relate to the lapping of structurally-equivalent bevel gear pairs and structurally-equivalent hypoid gear pairs.

At least some embodiments are based on a type of the closed-loop approach, in which a first lapping procedure is intentionally controlled by the use of removal variables or parameters (for example, in the form of removal coefficients). The removal variables define the removal behavior of the lapping. By way of the use of this method, an ease-off which approximates a target ease-off within tolerances can already be achieved for a first gear wheel pair after the lapping. Under certain circumstances, after carrying out the first lapping procedure, it is necessary to carry out a second, adapted lapping procedure to achieve the target ease-off.

The tooth flanks of the gear wheel pair are measured after the lapping to ascertain the actual ease-off by computer and/or analytically. A possible deviation of the actual ease-off from the target ease-off is then used for the purpose of performing a correction or compensation for the further lapping of the gear wheel pair or for the lapping of a further gear wheel pair. It is thus possible to control the lapping in such a way that the actual ease-off is maintained as much as possible in a target corridor defined by the target ease-off.

In at least some embodiments, in the scope of an iterative approach, which is designed for lapping at least one gear wheel pair of a plurality of structurally-equivalent gear wheel pairs, the target ease-off and the actual ease-off of a first gear wheel pair are used to be able to make a corrective and targeted intervention in the lapping method of this first gear wheel pair—if this pair has a sufficiently large oversize after a first lapping procedure to carry out a second, adapted lapping procedure—or in the lapping method of a second gear wheel pair. This intervention results in a rapid convergence of the method.

The method of at least some embodiments is based on a definition of the intervention of the two gears when they are paired with one another. This intervention is described—as described—on the basis of the ease-off. Moreover, the method is based on fine machining of the flanks by means of a lapping procedure, which is successively corrected in a type of a closed-loop approach. In such a closed-loop lapping method, a finish machining tool is not used, but rather the two gears are rolled on one another with use of a lapping agent to achieve a target ease-off.

At least some embodiments are built on the removal behavior or the removal rate or removal work, respectively, having been previously ascertained empirically and/or by simulation. The removal behavior can be empirically ascertained, for example, in that the lapping method is carried out and analyzed on multiple wheelset pairs. If this lapping method is carried out repeatedly, for example, the speed and the braking torque can be acquired for multiple points of a point set, wherein the relative location of the two gears of the wheelset is changed and the relative location for the respective points is also acquired while this lapping method is carried out. This means the speed and the braking torque are acquired and stored for changing relative positions.

The removal behavior or the removal rate or removal work, respectively, can be ascertained and stored in at least some embodiments in the form of removal variables (for example, in the form of removal coefficients).

In the ascertainment of the removal behavior, for example, the braking torque for the respective points can also be acquired, since this torque has a significant influence on the removal work or removal rate.

In the ascertainment of the removal behavior, for example, the speed for the respective points can also be acquired, since this has a significant influence on the removal work or removal rate.

In at least some embodiments, the removal variables are used (for example, in the form of removal coefficients), to be able to carry out the corresponding lapping procedure in an NC-controlled manner.

In at least some embodiments, the removal variables are used (for example, in the form of removal coefficients) to be able to simulate the corresponding lapping procedure in a software-controlled manner (for example, in the scope of a reverse simulation of a lapping procedure).

In at least some embodiments, topography data are provided before the lapping (these data can be loaded from a database, provided by software, or they can be measured by a measuring device—for example, by a coordinate measuring device). In addition, topography data are ascertained after the lapping (these data can be measured by measuring device). These topography data are related to one another, i.e., these topography data are relatively positioned in relation to one another to thus be able to ascertain by computer and/or analytically the difference (referred to here as the deviation) between the target ease-off and the actual ease-off for multiple points of a point set.

In the case of the mentioned relating to one another of the topography data, at least some embodiments are based on points also being incorporated which do not change during the lapping. In this case, these can be, for example, (fixed) points of a point set, which are located in a region of the corresponding gear wheel which is not reached by the counter gear during the lapping. These (fixed) points at which no removal has occurred during the lapping are used in these embodiments of being able to be able to place the topography data before the lapping in an unambiguous relationship with the topography data after the lapping. For example, the topography data before the lapping can be provided at the points of a first measurement grid and the topography data after the lapping can be provided at the point of a second measurement grid. The first measurement grid can now be brought into an unambiguous spatial relationship with the second measurement grid, since both measurement grids comprise (fixed) points which have not changed during the lapping. The actual geometry (also called starting geometry or starting topography) of the two gears before the lapping can thus be unambiguously related to the geometry of the two gears after the lapping and the ease-off before the lapping and the ease-off after the lapping can be computed.

The starting geometry or starting topography can be imported in such embodiments, for example, from a database or (design) software. However, it can also be measured (for example, by a measuring device).

At least some embodiments enable the specification of a target ease-off for multiple structurally-equivalent bevel gear or hypoid gear pairs and carrying out a monitored, NC-controlled lapping method, for example, to already produce an actual ease-off from the first or, for example, from the second pair, which corresponds to the target ease-off or is within a tolerance range, which can be viewed as a target corridor.

In at least some embodiments, a lapping procedure is used, the sequences of which are completely defined. The definition of this lapping procedure includes establishing multiple relative positions, moving one gear in relation to the other gear, and holding (if holding is provided) in the various relative positions. Moreover, it is established which flank of which gear comes into contact with which flank of the counter gear and which gear is driven and which gear is braked. I.e., in this lapping procedure, the relative positions (called relative location), the paths between these positions, and the torque load are defined. The lapping procedure can thus be reproduced again and again and enables a direct comparability of the results in this way.

In the embodiments which are based on the use of a lapping procedure carried out reproducibly, the correction or compensation can be applied, for example, to the linear movement of one gear in relation to the other gear, and/or the correction or compensation can be applied to the holding duration of the holding in the various relative positions. The correction or compensation can additionally or alternatively also be applied to the torque load.

This summary is not exhaustive of the scope of the aspects and embodiments of the invention. Thus, while certain aspects and embodiments have been presented and/or outlined in this summary, it should be understood that the inventive aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow, but in any case are not exhaustive or limiting.

It should also be understood that any aspects and embodiments that are described in this summary and elsewhere in this application and do not appear in the claims that follow are preserved for later presentation in this application or in one or more continuation patent applications.

### BRIEF DESCRIPTION OF THE DRAWINGS

Exemplary embodiments, which are understood not to be limiting, will be described in greater detail hereafter with reference to the drawings.

FIG. 1 schematically shows a top view of a known lapping device for engaging a pinion and a crown gear and rolling them on one another;

FIG. 2 schematically shows a side view of a closed-loop device that comprises a lapping device and a measuring device;

FIG. 3A schematically shows an embodiment which comprises software;

FIG. 3B schematically shows an embodiment which comprises multiple software components or modules;

FIG. 4A schematically shows steps of a method in the form of a flow chart;

FIG. 4B schematically shows subsequent steps of the method illustrated in FIG. 4A.

### DETAILED DESCRIPTION

Terms are used in conjunction with the present description which are also used in relevant publications and patents. However, it is to be noted that the use of these terms is merely to serve for better comprehension. The inventive concepts and the scope of protection of the claims for protection are not to be restricted in the interpretation by the specific selection of the terms. The invention may be readily transferred to other term systems and/or technical fields. The terms are to be applied accordingly in other technical fields.

Lapping refers here to the intermeshing rotation of two gearing elements (for example, a crown gear Tn and a pinion Rn, wherein n is a whole number greater than or equal to 1), wherein contact occurs in the engagement region between the tooth flanks of the gearing elements Tn and Rn, and wherein a lapping agent is introduced so that a mutual material removal occurs on the gearing elements Tn and Rn. The means for introducing the lapping agent are not shown in the figures, since such solutions are well known to a person skilled in the art. The lapping of bevel gear teeth as such is also presumed to be known.

At least some embodiments relate to a type of a closed-loop approach for lapping one or more than one gear wheel pair on the basis of a previously defined target ease-off. The target ease-off is used in this case as a quasi-target specification or target corridor.

The ease-off defines or determines the interaction of the teeth of two meshing gears. The ease-off topography or function is the minimum of the contact distance of the tooth flanks when rolling the gears in the theoretically constant gear ratio that is defined by the number of teeth. The ease-off function for instance can be displayed as a 3-dimensional graph over the radial projection of the flank of one of the mating gears.

The ease-off of a gear wheel pair result from the interaction and/or rolling of the flank topographies of gear and counter gear. Ease-off is defined as a global minimum of the distance function between gear and counter gear as they roll through in the predetermined, constant transmission ratio (for example, using the following number of teeth Z1=18, Z2=45, a transmission ratio=45/18=2.5 results). The ease-off can also be considered to be a representation of the tooth flank distance of the tooth flanks of a gear wheel pair. The ease-off is typically ascertained for a plurality of points on the tooth flanks of the two gears Tn, Rn of a gear wheel pair.

The target ease-off of a gear wheel pair can be computed/established in at least some embodiments in the scope of a software-assisted design method (for example, using the KIMoS™ software from Klingelnberg GmbH), for example, during the wear pattern development.

The target ease-off of a gear wheel pair can be established in at least some embodiments by multiple parameters. These parameters comprise, for example, the spiral angle difference, the flank angle difference, the longitudinal and/or vertical crowning, and the torsion.

The lapping can be intentionally controlled in a lapping device 100 by an NC-controller by way of the closed-loop approach, which is described and claimed here.

During the rolling of the teeth of bevel gear pinion and crown gear of a bevel gear pair, sliding occurs in the tooth vertical direction upon lapping. In the gears of a hypoid gear pair, sliding in the tooth longitudinal direction is overlaid on the sliding in the tooth vertical direction. The local relative velocity for the contact points of a point set can be computed from these sliding movements. This means the relative velocities acting at the contact points can be ascertained by computer if the geometry of the gears and the rotational velocities around the rotational axes TA and RA are known (which is the case in an NC-controlled lapping device 100). This relative velocity is a variable which can be incorporated into the ascertainment of a local removal rate.

However, the relative velocity of the contacting tooth flanks only describes one aspect of the lapping. In addition, for example, the abrasive effect of the particles of the lapping agent is also ascertained and taken into consideration. In this case, the tooth flanks of the two gears Tn, Rn have to be considered simultaneously as workpiece and as tool during the lapping. It is to be taken into consideration that there are various removal mechanisms in lapping (for example, a cutting removal behavior and a furrowing removal behavior), which are overlaid here. Depending on the dominant removal mechanism, different removal appearances and removal rates, i.e., a different removal rate in the scope of the lapping method, are therefore to be expected.

In this case, there is an entire array of variables (e.g., the surface hardness of the tooth flanks, the present topography of the tooth flanks after the hardening, the concentration, size, and quality of the particles of the lapping agent, the lubricating effect of the lapping agent, etc.), which have a direct or indirect influence on the removal rate. In addition, the removal rate varies from point to point because of dynamic influences.

At least some embodiments are based on an approach which is referred to here as an iterative closed-loop approach. In this iterative approach, a first wheelset is lapped by means of a previously defined first lapping procedure in the scope of a method sequence. This wheelset is then measured to ascertain the actual ease-off by computer and/or analytically. If this actual ease-off does not correspond to the desired target ease-off, or if the actual ease-off is outside a tolerance window of the target ease-off, correction or compensation values KW are thus ascertained for the subsequent further lapping of the first wheelset or for the subsequent lapping of a further wheelset. These correction or compensation values can be used in at least some embodiments, for example, for the purpose of adapting the first lapping procedure (the adapted first lapping procedure is referred to here as the adapted lapping procedure or as the second lapping procedure).

The adaptation of the lapping procedure can be carried out iteratively before the lapping of each wheelset, or the adaptation can be carried out from time to time. In the settled state of the method of at least some embodiments, it can be sufficient if the lapping procedure is adapted, for example, after every 10th wheelset pair.

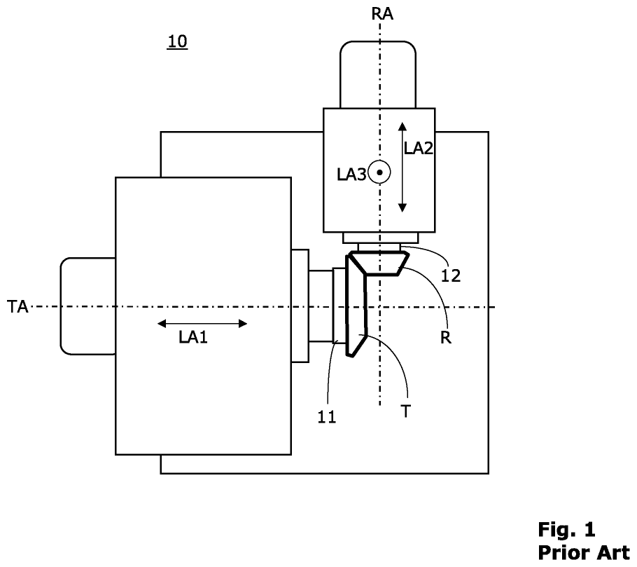

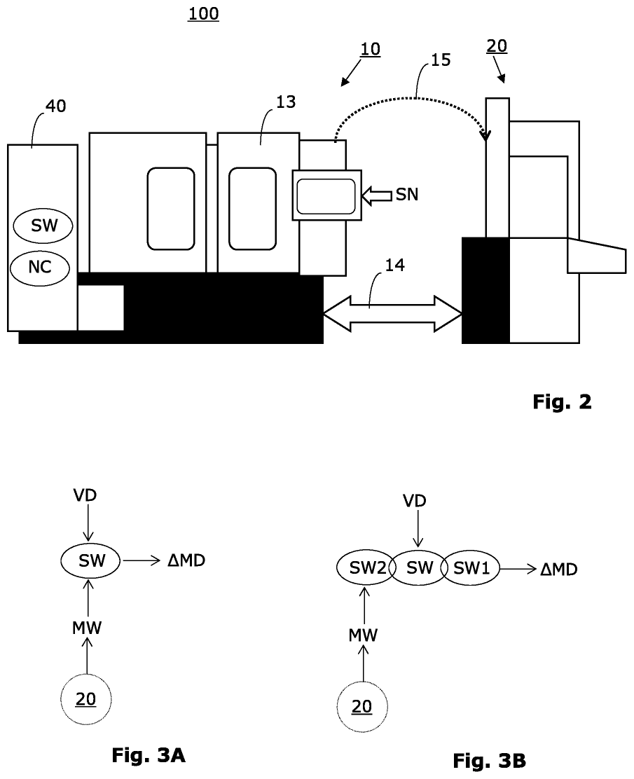

In the scope of the method, for example, the device 10 can be used which was described at the outset in conjunction with FIG. 1. FIG. 2 shows this device 10 (in the interior of a machine housing 13 shown by way of example here) together with a measuring device 20. The device 10 forms, together with the measuring device 20, an overall constellation (configuration) which is referred to as a closed-loop device 100. This means the two devices 10, 20 have a communication connection to one another in such a way that, for example, measured values MW, which were ascertained in the measuring device 20, can be transferred to the device 10. The communication connection is provided here with the reference sign 14 and is symbolized by a double arrow. In addition, a control cabinet 40 is shown in FIG. 2, which can contain, for example, the NC-controller NC of the device 10. Software SW (and/or software or a software module SW1, SW2), which is designed, for example, for the purpose of implementing the method of at least some embodiments, can be provided in the control cabinet 40, or at another location of the device 100. The software SW may be incorporated in at least some embodiments into the communication between the two devices 10, 20.

The arrow 15 is to indicate that a gear wheel pair is transferred out of the device 10 to the measuring device 20. This transfer 15 can take place manually, semi-automatically, or fully automatically in at least some embodiments.

The lapping device 10 can comprise a data interface or a user interface SN in at least some embodiments, which enables it to define the removal variables, for example the lapping coefficients αL.

One of the following approaches can be implemented in at least some embodiments:
The computation of the lapping settings and/or corrections takes place on an external computer, wherein the lapping coefficients αL have to be provided to this computer;
The computation is performed on lapping device 10, wherein the lapping coefficients αL have to be provided to the lapping device 10;
The computation of the corrections is performed on measuring device 20, wherein the lapping coefficients αL have to be provided to the measuring device 20.

Details on the simulation and determination of removal variables can be inferred, for example, from the following publication: “Experimental studies and simulation of hypoid gear lapping”, B. Schlecht, F. Rudolph, International Conference on Gear Production 2017, 13-14 Sep. 2017, Garching bei Munchen.

The lapping device 10 and the measuring device 20 can be coupled to one another, as indicated by the double arrow 14. The term coupling is used to indicate that the machine 10 and the measuring device 20 are at least coupled with respect to communication (i.e., for the data exchange). This communication coupling (also called networking) presumes that the machine 10 and the measuring device 20 understand the same or a compatible communication protocol, and both follow certain conventions with regard to the data exchange. For the data exchange, for example, software or a software module SW2 can be used, as will be described hereafter.

The term coupling can also mean that the machine 10 and the measuring device 20 are not only networked but rather also mechanically connected to one another or completely integrated. The measuring device 20 can be integrated into the machine 10 or directly connected thereto in at least some embodiments.

The machine 10 and the measuring device 20 can form a closed processing and communication loop (called closed loop) in at least some embodiments.

The various axes of the machine 10 and/or the various axes of the measuring device 20 can be controlled in at least some embodiments, for example, by a common NC controller (which can be arranged, for example, in the control cabinet 40).

However, it is also possible to equip both the machine 10 and the measuring device 20 with a separate NC-controller in each case. In this case, the networking for the data exchange can be established, for example, between the NC-controllers (for example, via a network).

The machine 10 and/or the measuring device 20 can be controlled in at least some embodiments, for example, by common software SW (which can be installed, for example, in the control cabinet 40).

The axes which are controlled by an NC-controller are numerically controlled axes. The individual axis movements can be numerically controlled by the NC-controller(s) by way of such a constellation. It is important that the individual movements of the axes of the machine 10 are performed during lapping as is established on the basis of a sequence or a sequence program for the lapping procedure. The movements of the axes of the machine 10 can thus take place in a coordinated and reproducible manner. This coordination of the movements can be performed in at least some embodiments by the NC-controller 40 and/or the software SW.

The target ease-off for a gear wheel pair (referred to here as the gear wheel pair Tn, Rn) is specified using suitable software or a software module SW1 (for example, using the software KIMoS™ from Klingelnberg GmbH, Germany). Software or a software module SW1 can, for example, at the end of a design process, provide the target ease-off in the form of a data set, which can be organized, for example, like a matrix. This data set defines the pairing of a crown gear T1 and a pinion R1 in principle. The machine kinematics required for this purpose for the lapping of the two gears T1, R1 can be ascertained on the basis of the data set. The lapping of the two gears T1, R1 of a first gear wheel pair is referred to here as the first lapping procedure. The machine kinematics of the first lapping procedure can be ascertained or computed by simulation, for example, on the basis of a (data) model of the machine 10 to be used and using removal variables (for example, in the form of removal coefficients).

Since there are also other approaches to specify the target ease-off of the first gear wheel pair, the generic term specification data VD is used hereafter for the corresponding data, wherein these specification data VD quasi-define the engagement of the two gears T1, R1 when they are paired with one another.

The specification data VD can also describe the machine kinematics in at least some embodiments (wherein, for example, on the basis of a model of the lapping device 10 to be used, the setting values of this device 10 are ascertained) or the machine kinematics can be provided in the form of an additional (separate) data set.

These specification data VD can be transferred, for example, to a process. The process, which can be implemented, for example, as software or a software module, can in such a case translate the specification data VD into machine data MD (sometimes also called machine code or process data), which are converted by the NC-controller of the machine 10 into coordinated movement sequences.

The machine 10 now laps the two gears T1, R1, for example, as specified on the basis of the machine data MD for the first lapping procedure. After this lapping machining has been completed, the two gears T1, R1 are transferred (directly or indirectly) to the measuring device 20 (as indicated by the arrow 15). A predefined measurement sequence is carried out in the measuring device 20 and relative axial movements of the NC-axes of the measuring device 20 are carried out in the scope of this measurement sequence to obtain measured values MW, which are suitable for ascertaining the actual ease-off. The ascertainment of the actual ease-off can be performed, for example, directly in the measuring device 20 or, for example, by software or a software module SW2.

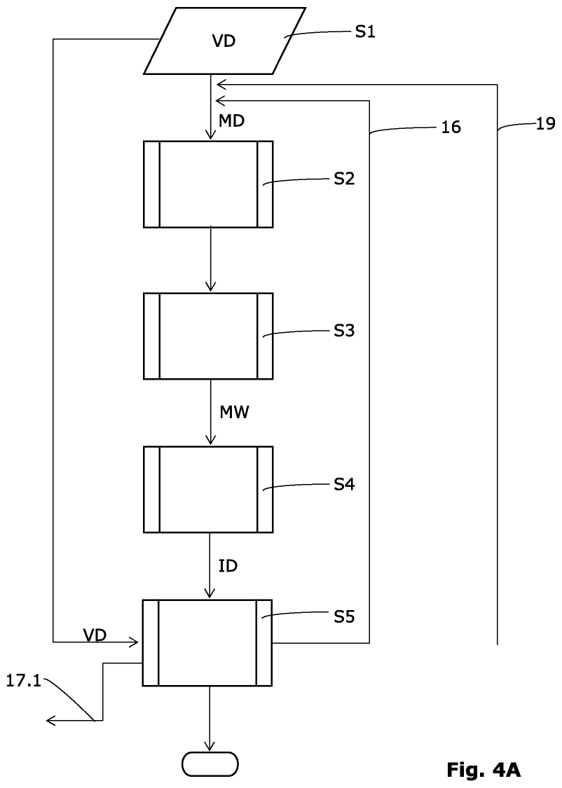

FIG. 3A shows an embodiment in which functionalities are implemented in the software SW. The software SW can be used, for example, to ascertain the actual ease-off from the measured values MW, which are supplied by the measuring device 20. The software SW can compute correction values or compensation values ΔMD from the actual ease-off and the target ease-off, which is contained in the specification data VD. In an optional intermediate step, deviations ΔVD can be computed and provided.

FIG. 3B shows an embodiment in which the software SW is linked to two software modules SW1 and SW2. The software module SW2, if provided, can be used, for example, to ascertain the actual ease-off from the measured values MW, which are supplied by the measuring device 20. The software SW can compare the actual ease-off to the target ease-off, which is contained in the specification data. The software module SW1, if provided, can be used, for example, to compute correction values or compensation values ΔMD from the result of the comparison which was carried out by the software ΔSW. In an optional intermediate step, deviations ΔVD can be computed and provided.

The schematic illustrations of FIGS. 3A and 3B are to be understood as examples. There are also other options for organizing the data transmission and the computation and conversion steps.

For example, the optimization algorithm of the software KOMET™ from Klingelnberg GmbH, Germany can be used to convert the measured values MW, which were ascertained by means of the measuring device 20, into corrections (for example, in the form of correction values or compensation values ΔMD) of the lapping procedure to be executed thereafter.

In the ideal case, the actual ease-off of the two gears T1, R1 is absolutely identical to the target ease-off, i.e., the actual data ID correspond to the specification data VD. In this case, which is of solely theoretical significance, the machine data MD can be stored, for example, to lap further structurally-equivalent gear wheel pairs (for example, in series).

In practice, however, deviations (referred to here by ΔVD) between the actual data ID and the specification data VD, or between the target ease-off and the actual ease-off, respectively, are ascertained upon measurement.

In at least some embodiments, these deviations ΔVD can be supplied, for example, by the measuring device 20 directly or indirectly to the software SW and/or to the NC-controller of the machine 10.

Depending on the embodiment, for example, the software SW and/or the NC-controller can now ascertain correction values ΔMD for the control of the machine 10 and transmit them to the machine 10. However, it is also possible that the software SW and/or the NC-controller ascertains the deviations ΔVD and/or the correction values ΔMD from measured values, which are provided by the measuring device 20.

The correction values ΔMD are taken into consideration either during the further lapping of the first gear wheel pair or during the lapping of the following gear wheel pair. The correction values ΔMD can be linked, for example, to the machine data MD of the first lapping procedure to adapt the sequence control of the following lapping procedure. Or new machine data MD for the sequence control of the following lab procedure are computed on the basis of the correction values ΔMD.

The mentioned deviations ΔVD may be used in at least some embodiments to adapt the geometric set values and/or the movements of the machine 10.

The described closed-loop approach, but also other network solutions of a similar type enable progressive optimization of the ease-off in the lapping of structurally-equivalent gear wheel pairs.

The software SW and/or SW1 and/or SW2 can in at least some embodiments comprise at least one (hardware and/or software) interface, which is designed for data communication with the machine 10 and/or with the measuring device 20.

The software SW and/or SW1 and/or SW2 can be designed in at least some embodiments to compute the correction values ΔMD from the measured values MW, which describe the actual ease-off, and from values (for example, from the corresponding specification data VD), which describe the target ease-off.

These correction values ΔMD can be computed in at least some embodiments directly from the measured values MW of the actual ease-off and values (for example, from the corresponding specification data VD) of the target ease-off, or deviations ΔVD are first computed from the measured values MW and the values (for example, from the corresponding specification data VD). In the latter case, the computation of the correction values ΔMD is then performed from the deviations ΔVD.

The network processing environment (referred to here as closed-loop device 100) is designed in at least some embodiments for carrying out the following method. In this case, the following steps are executed.

Specifying or providing (step S1) a target ease-off for a pairing of two gear wheels of a first gear wheel pair T1, R1 from a number n of structurally-equivalent gear wheel pairs Tn, Rn, wherein n is a whole number greater than or equal to 1.

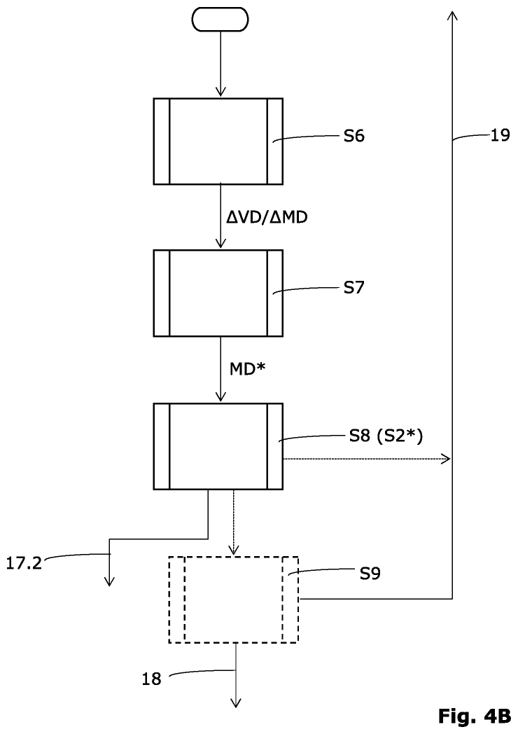

The target ease-off can be provided, for example, as indicated in FIG. 4A, in the form of specification data VD. The specification or provision (step S1) of the target ease-off, or the corresponding specification data VD, respectively, can, in at least some embodiments, for example,
be computed/established in the scope of a software-assisted design method, as already described, or
after the hardening of an already cut gear wheel pair, a measurement of the actual geometry/actual topography of the two gear wheels of the gear wheel pair can be performed, to then establish a target ease-off on the basis of actual geometry/actual topography, or
the target ease-off can be loaded from a memory, for example, or the target ease-off is established/defined by ascertaining the influence of the lapping on the basis of a reverse simulation. The geometry/topography of the two gear wheels can be ascertained after the hardening (i.e., before the lapping) by the reverse simulation. In addition, it can be ascertained how the geometry/topography of the two gear wheels has to appear after the gear cutting (for example, by means of milling). If the geometry/topography after the gear cutting and/or the geometry/topography after the hardening is/are known, a suitable target ease-off can be established/defined for a gear wheel pair.

A reverse simulation is a simulation which starts from the result to be achieved (e.g., a target ease-off). The simulation is then performed step-by step with a backwards orientation so as to find the starting point or data (e.g., the actual geometry also called starting geometry or starting topography) of two gears to be paired.

Carrying out a first lapping procedure (step S2) on the two gear wheels of the first gear wheel pair T1, R1 then follows. The individual NC-controlled movements of the axes of the machine 10 are performed in the scope of the first lapping procedure as established on the basis of a sequence or a sequence program. The software SW can interact with the NC-controller of the machine 10 here, for example, wherein the software SW transfers machine data MD to the NC-controller, as schematically indicated in FIG. 4A.

Before carrying out the first lapping procedure (step S2), the following preparatory steps can optionally be carried out in at least some embodiments:
chucking a first gear wheel T1 of a gear wheel pair T1, R1 in a lapping device 10, so that the first gear wheel T1 is rotatable around a first rotational axis TA of the lapping device 10,
chucking a second gear wheel R1 of the gear wheel pair T1, R1 in the lapping device 10, so that the second gear wheel R is rotatable around a second rotational axis RA of the lapping device 10,
executing relative movements by means of the lapping device 10 to engage the first gear wheel T1 with the second gear wheel R1,
introducing a lapping agent into the lapping device 10.

After step S2, the two gears of the first gear wheel pair T1, R1 are subjected to a measurement procedure. Carrying out the measurement procedure (step S3) is performed to acquire multiple measured values MW on the tooth flanks of both gear wheels. Carrying out the measurement procedure (step S3) can be performed in the machine 10 or in a measuring device 20. If step S3 is carried out inside the machine 10, the gears T1, R1 do not have to be re-chucked. If step S3 is carried out in a separate measuring device 20, the gears T1, R1 have to be transferred beforehand to the measuring device 20, as symbolized by the arrow 15 in FIG. 2.

The ascertainment (step S4) of the actual ease-off of the first gear wheel pair T1, R1 from the measured values MW now follows. The ascertainment of the actual ease-off can be performed by computer and/or analytically in at least some embodiments. Software SW and/or SW2 may be used in at least some embodiments, which enables the actual ease-off to be ascertained on the basis of measured values MW, which were measured after the lapping on the first gear wheel pair T1, R1.

Step S4 can be carried out at various points of the entire device 100, as was already described beforehand on the basis of various embodiments. The actual ease-off can be described in at least some embodiments, for example, in the form of actual data ID.

The comparison (step S5) of the actual ease-off to the target ease-off now follows. The comparison is used to ascertain deviations between the actual ease-off and the target ease-off. The ascertainment of the deviations can be performed by computer and/or analytically in at least some embodiments. Software which enables the deviations to be computed may be used in at least some embodiments.

If the actual ease-off should already be in a tolerance window, which is defined, for example, as the target ease-off ±tolerance value, the iterative method can be terminated and the next gear wheel pair T2, R2 of the set of structurally-equivalent gear wheel pairs Tn, Rn can be subjected to steps S2 to S5. This backward branching of the method is symbolized by a path 16 in FIG. 4A. In this special case, the first gear wheel pair T1, R1 can already be output at the end of step S5, as schematically illustrated by the path 17.1 in FIG. 4A.

However, if the actual ease-off is outside the tolerance window, the steps described hereafter are executed. These following steps are shown in FIG. 4B.

The ascertainment of correction values (step S6) follows. In the scope of this ascertainment, the correction values can be expressed in the form of changes and/or adaptations of the specification data VD. The ascertainment of the correction values can be performed by computer and/or analytically in at least some embodiments. Software which comprises an optimization algorithm may be used in at least some embodiments.

The correction values are referred to here as ΔVD. In the scope of this ascertainment, the correction values ΔVD expressed in the form of changes and/or adaptations of the machine data MD. In this case, the correction values are referred to as ΔMD.

In following step S7, a second (adapted) lapping procedure is defined on the basis of the correction values ΔVD or ΔMD.

In FIG. 4B, carrying out the second (adapted) lapping procedure is also provided with the reference sign S2*, to express that the second (adapted) lapping procedure, in at least some embodiments, can be defined, for example, by the adaptation of the first lapping procedure (step S2) or can be derived therefrom.

For the purposes of carrying out the second lapping procedure (step S8), for example, machine data MD* can be ascertained on the basis of the correction values ΔVD or ΔMD and transferred to the machine 10.

If the actual ease-off of the first gear wheel pair T1, R1 is not yet in the tolerance window (which was ascertained in the scope of the comparison in step S5), which is defined, for example, as target ease-off ±plus tolerance value, the first gear wheel pair T1, R1 can be subjected to a further, adapted lapping procedure (step S8 in FIG. 4B). Machine data MD*, which were adapted/corrected, are used for this further, adapted lapping procedure.

However, carrying out a further, adapted lapping procedure on the first gear wheel pair T1, R1 is only reasonable if the two gears T1, R1 have a sufficiently large oversize after the first lapping procedure.

If the first gear wheel pair T1, R1 is not subjected to a further, adapted lapping procedure, the gears of a second gear wheel pair T2, R2 are thus introduced into the machine.

Before carrying out the adapted lapping procedure (step S8) on the second gear wheel pair T2, R2, in at least some embodiments, the preparatory steps can be carried out for the two gears T2, R2 which were already described on the basis of the first gear wheel pair T1, R1 in conjunction with step S2.

At the end of step S8, the respective gear wheel pair (for example, the twice-lapped first gear wheel pair T1, R1 or the once-lapped second gear wheel pair T2, R2) can be output, as schematically shown by the path 17.2 in FIG. 4B.

Optionally, a measurement can again be performed in a downstream step S9, to acquire measured values which enable the computation and checking of the actual ease-off, for example, of the second gear wheel pair T2, R2. The measurement procedure which was already described as step S3 can be used here. This optional step S9 can be executed to ascertain whether the actual ease-off is now in the tolerance window of the target ease-off. However, it is also possible to carry out step S9 only from time to time (for example, for every 10th gear wheel pair). If the actual ease-off is in the tolerance window, the second gear wheel pair T2, R2 can thus be output, as schematically shown by the path 18 in FIG. 4B.

If the method should not already converge during the lapping of the first gear wheel pair T1, R1 or the second gear wheel pair T2, R2, the steps can optionally be repeated for a further gear wheel pair Tn, Rn. This further branching back of the method is symbolized by a path 19 in FIGS. 4A, 4B. The branching back of the method can also begin at step S8, as indicated in FIG. 4B.

To be able to execute the lapping in a targeted manner in the scope of the method, in at least some embodiments, the removal behavior of the lapping device 10 during the lapping can be taken into consideration. The removal behavior can be empirically ascertained, for example, on the basis of preceding lapping attempts on structurally-equivalent gear wheel pairs, and stored. The removal behavior can be ascertained, for example, by simulation, and stored.

The instantaneous load torque and/or the speed and/or the holding time (if the lapping procedure provides a holding of the relative movements of the corresponding point) might be acquired during the ascertainment of the removal behavior for a plurality of points on the tooth flanks of crown gear Tn and pinion Rn. In addition, for example, the coordinates of the corresponding points are acquired in three-dimensional space. An array of parameters and/or values can thus be acquired and stored per point. Removal variables, for example, in the form of lapping coefficients αL, can thus be acquired and stored per point.

It is also possible during the ascertainment of the removal behavior to acquire the relative travel paths (which are traveled along due to the relative displacement of crown gear Tn and pinion Rn in the machine 10) from point to point, and one or more of the method-relevant parameters or values for the lapping.

The removal coefficient αL, which is optionally ascertained for a plurality of points, enables a statement to be made about the local lapping removal at each of the individual points. In addition, a statement about the lapping removal distribution on the flanks of the gears Tn, Rn can also be made on the basis of a set of removal coefficients αL. The lapping can be intentionally controlled by the NC-controller of the device 10 on the basis of the removal coefficients αL.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method comprising:
a) specifying a target ease-off for a first pair of gear wheels of a plurality of structurally-equivalent gear wheel pairs;
b) performing a first lapping procedure on the first pair of gear wheels;
c) measuring tooth flanks of the first pair of gear wheels and acquiring therefrom multiple measurements of the tooth flanks;
d) calculating an actual ease-off of the first pair of gear wheels using said measurements;
e) determining deviations of the actual ease-off relative to the target ease-off;
f) determining, using the deviations, correction values adapted to correct said deviations;
g) defining a modified lapping procedure based on the correction values; and
one or more of
h) performing the modified lapping procedure on the first pair of gear wheels; or
i) performing the modified lapping procedure on a second pair of said structurally-equivalent gear wheel pairs.

2. The method according to claim 1, comprising performing step h) only when the first pair of gear wheels is oversized by a predetermined amount relative to a target size after performing the first lapping procedure.

3. The method according to claim 2, wherein step h) is performed in a lapping device, and further comprising removing the first pair of gear wheels from the lapping device following step h).

4. The method according to claim 1, including performing step i) in a lapping device, and further, after step i):
measuring tooth flanks of the second pair and acquiring therefrom multiple measurements of said tooth flanks of the second pair;
calculating an actual ease-off of the second pair using said measurements thereof; and
determining whether the actual ease-off of the second pair is within a tolerance window of the target ease-off; and
when the actual ease-off of the second pair is within the tolerance window, removing the second pair from the lapping device.

5. The method according to claim 3, further comprising performing steps b) to i) on further pairs of said structurally-equivalent gear wheel pairs.

6. The method according to claim 1, wherein the target ease-off and the actual ease-off define an engagement of said gear wheels of said first pair while paired with one another.

7. The method according to claim 1, wherein the ease-off is defined by a set of discrete ease-off values or by an ease-off function.

8. The method according to claim 1, wherein the step of specifying the target ease-off comprises performing a simulation of or a computation of removal of material from said gear wheels of said first pair during said first lapping procedure for a plurality of points on said tooth flanks of said gear wheels of the first pair using material removal parameters for said first lapping procedure.

9. The method according to claim 8, wherein the simulation defines a reverse simulation.

10. The method according to claim 8, wherein the material removal parameters define lapping coefficients.

11. The method according to claim 1, further comprising one or more of before step b) or before step i), the following steps:
chucking a first gear wheel of the first pair in a lapping device, wherein the first gear wheel is rotatable about a first rotational axis defined by the lapping device,
chucking a second gear wheel of the first pair in the lapping device, wherein the second gear wheel is rotatable around a second rotational axis defined by the lapping device, and
engaging the first gear wheel with the second gear wheel by executing, with the lapping device, relative movement of the first gear wheel and the second gear wheel.

12. The method according to claim 11, comprising performing the first lapping procedure and the modified lapping procedure with the lapping device, and introducing a lapping agent into the lapping device during the first lapping procedure and the modified lapping procedure so that abrasive particles of the lapping agent remove material from the first gear wheel and the second gear wheel in an engagement region therebetween.

13. The method according to claim 2, wherein the target ease-off and the actual ease-off define an engagement of said gear wheels of said first pair while paired with one another.

14. The method according to claim 3, wherein the target ease-off and the actual ease-off define an engagement of said gear wheels of said first pair while paired with one another.

15. An apparatus comprising:
a lapping device comprising multiple NC-controlled axes and an NC controller and configured to perform a first lapping procedure on two gear wheels of a first gear wheel pair; and
a measuring device configured to measure tooth flanks of the two gear wheels of the first gear wheel pair and acquire therefrom multiple measurements of the tooth flanks;
wherein the apparatus is configured to
determine an actual ease-off of the first gear wheel pair from said measurements,
determine deviations of the actual ease-off relative to a target ease-off for the first gear wheel pair,
calculate, using the deviations, correction values adapted to correct said deviations, and
define a modified lapping procedure based on the correction values; and
wherein the lapping device is further configured to perform the modified lapping procedure on one or more of (i) the two gear wheels of the first gear wheel pair; or (ii) two gear wheels of a second gear wheel pair.

16. The apparatus according to claim 15, wherein the first lapping procedure and the modified lapping procedure are defined by material removal parameters for a plurality of points on, respectively, said tooth flanks of said gear wheels of said first gear wheel pair and tooth flanks of said gear wheels of said second gear wheel pair.

17. The apparatus according to claim 16, wherein the material removal parameters define lapping coefficients.

18. The apparatus according to claim 16, further comprising a data interface or user interface configured to define the material removal parameters.

19. The apparatus according to claim 18, wherein the material removal parameters define lapping coefficients.

20. The apparatus according to claim 18, wherein the lapping device and the measuring device are configured to communicate with one another.

21. The apparatus according to claim 15, wherein the lapping device and the measuring device are configured so that re-chucking of the two gear wheels of the first gear wheel pair is not required between the first lapping procedure and acquiring said measurements.

22. The apparatus according to claim 15, further comprising at least one software program or at least one software module configured to determine said deviations between the actual ease-off and the target ease-off and to define the modified lapping procedure therefrom by modifying the first lapping procedure.

23. The apparatus according to claim 15, wherein the lapping device and the measuring device are configured to communicate with one another.

24. The apparatus according to claim 16, wherein the lapping device and the measuring device are configured so that re-chucking of the two gear wheels of the first gear wheel pair is not required between the first lapping procedure and acquiring said measurements.
